(19) United States
(12) Patent Application Publication
(10) Pub. No.: US 2026/0089776 A1
(43) Pub. Date: Mar. 26, 2026

(54) NEXT GENERATION INTERFACE CONFIGURATION METHOD AND APPARATUS

(71) Applicant: ELECTRONICS AND TELECOMMUNICATIONS RESEARCH INSTITUTE, Daejeon (KR)

(72) Inventors: Jaesheung SHIN, Daejeon (KR); Sook Yang KANG, Daejeon (KR); Myungsan BAE, Daejeon (KR); Hyung Deug BAE, Daejeon (KR); Jae Wook SHIN, Daejeon (KR); Chahyeon EOM, Daejeon (KR); Sung-Min OH, Daejeon (KR); You Sun HWANG, Daejeon (KR)

(73) Assignee: ELECTRONICS AND TELECOMMUNICATIONS RESEARCH INSTITUTE, Daejeon (KR)

(21) Appl. No.: 19/335,830

(22) Filed: Sep. 22, 2025

(30) Foreign Application Priority Data
Sep. 24, 2024 (KR) 10-2024-0129048
Sep. 4, 2025 (KR) 10-2025-0125698

(51) Int. Cl. H04W 76/10; H04W 84/06

(52) U.S. Cl. CPC H04W 76/10; H04W 84/06

(57) ABSTRACT

A method of a first satellite may comprise: receiving one or more configuration update messages from one or more satellites connected to the first satellite; determining an anchor satellite among the one or more satellites based on the one or more configuration update messages; and establishing a connection with an access and mobility management function (AMF) entity connected to the anchor satellite.

### CROSS-REFERENCE TO RELATED APPLICATIONS

This application claims priority to Korean Patent Applications No. 10-2024-0129048, filed on Sep. 24, 2024, and No. 10-2025-0125698, filed on Sep. 4, 2025, with the Korean Intellectual Property Office (KIPO), the entire contents of which are hereby incorporated by reference.

### BACKGROUND

### 1. Technical Field

The present disclosure relates to a next generation (NG) interface establishment technique, and more particularly, to an NG interface establishment technique by a regenerative satellite.

### 2. Related Art

Communication networks (e.g. 5G communication networks, 6G communication networks, and the like) for providing communication services improved over existing communication networks (e.g. long term evolution (LTE), LTE-Advanced (LTE-A), and the like) are being developed. A 5G communication network (e.g. new radio (NR) communication network) can support not only a frequency band of 6 GHz or below but also a frequency band of 6 GHz or above. In other words, the 5G communication network can support an FR1 band and/or an FR2 band. The 5G communication network can support various communication services and scenarios compared to an LTE communication network. For example, usage scenarios of the 5G communication network may include enhanced Mobile BroadBand (eMBB), Ultra Reliable Low Latency Communication (URLLC), and massive Machine Type Communication (mMTC).

In a non-terrestrial network, satellites may be classified into transparent satellites and regenerative satellites. A transparent satellite performs frequency conversion, filtering, and amplification of an uplink radio frequency (RF) signal. A regenerative satellite perform amplification and conversion for an uplink RF signal before performing downlink transmission. The conversion of a signal may refer to at least one of decoding, demodulation, re-encoding, re-modulation, or filtering. In other words, a regenerative satellite may perform a role of a base station.

A regenerative satellite may be a non-geostationary orbit (NGSO) satellite. The regenerative satellite may traverse boundaries between gateway areas (covered by ground gateways) and AMF areas (covered by a ground core network, e.g. access management functions (AMFs)). When the regenerative satellite traverses these boundaries, establishment or release of a next generation (NG) interface between the satellite and the ground core network may be required.

However, since the regenerative satellite is not stationary relative to the ground, a feeder link between the regenerative satellite and a gateway may not be established. Accordingly, when a feeder link is not established, establishment or modification of the NG interface between the regenerative satellite and a ground-based AMF may be required through an inter-satellite link (ISL).

### SUMMARY

The present disclosure for resolving the above-described problems is directed to providing a method and an apparatus for establishing an NG interface by a regenerative satellite.

According to a first exemplary embodiment of the present disclosure, a method of a first satellite may comprise: receiving one or more configuration update messages from one or more satellites connected to the first satellite; determining an anchor satellite among the one or more satellites based on the one or more configuration update messages; and establishing a connection with an access and mobility management function (AMF) entity connected to the anchor satellite.

The establishing of the connection with the AMF entity may further comprise: determining an address of the first satellite based on an address of a gateway or an address relayed via the gateway, which is indicated by at least one of the one or more configuration update messages; and establishing a transport network layer (TNL) association with the AMF entity connected to the anchor satellite based on the address of the gateway or the address relayed via the gateway.

The establishing of the connection with the AMF entity may further comprise: performing a next generation (NG) setup procedure with the AMF entity based on the TNL association.

The establishing of the connection with the AMF entity may further comprise: performing a radio access network (RAN) configuration update procedure with the AMF entity based on the TNL association.

Each of the one or more configuration update messages may include at least one of: identification information of each of the one or more satellites, address information of each of the one or more satellites, identification information of a gateway connected to each of the one or more satellites, information on an address of the gateway connected to each of the one or more satellites, information on an address relayed via the gateway, identification information of an AMF entity connected to each of the one or more satellites, address information of the AMF entity connected to each of the one or more satellites, information on a hop count through an inter satellite link (ISL) between each of the one or more satellites and the first satellite, or information on traffic load through the ISL between each of the one or more satellites and the first satellite.

A hop count between the anchor satellite and the first satellite may be less than or equal to a hop count between the first satellite and at least one of the one or more satellites other than the anchor satellite.

According to a second exemplary embodiment of the present disclosure, a method of a second satellite may comprise: receiving, from a gateway, address information on an address of the gateway or information on an address relayed via the gateway; transmitting, to a first satellite connected to the second satellite, a configuration update message including the address information; and receiving, from the first satellite, a response message for the configuration update message.

The method may further comprise: establishing a connection with an access and mobility management function (AMF) entity connected to the gateway after receiving the address information, wherein the establishing of the connection with the AMF entity may comprise: determining an address of the second satellite based on the address information; and establishing a transport network layer (TNL) association with a core network entity connected to the gateway based on the address information.

The establishing of the connection with the core network entity may further comprise: performing a next generation (NG) setup procedure with the AMF entity based on the TNL association.

The establishing of the connection with the core network entity may further comprise: performing a radio access network (RAN) configuration update procedure with the core network entity based on the TNL association.

The configuration update message may be transmitted based on a comparison result between the address of the gateway indicated by the address information and an address of the second satellite, or a comparison result between the address relayed via the gateway and the address of the second satellite.

The configuration update message may include at least one of: identification information of the second satellite, address information of the second satellite, identification information of the gateway, information on the address of the gateway, information on the address relayed via the gateway, identification information of a core network entity connected to the second satellite, address information of the core network entity connected to the second satellite, information on a hop count through an inter-satellite link (ISL) between the second satellite and the first satellite, or information on traffic load through the ISL between the second satellite and the first satellite.

According to a third exemplary embodiment of the present disclosure, a first satellite may comprise at least one processor, wherein the at least one processor may cause the first satellite to perform: receiving one or more configuration update messages from one or more satellites connected to the first satellite; determining an anchor satellite among the one or more satellites based on the one or more configuration update messages; and establishing a connection with an access and mobility management function (AMF) entity connected to the anchor satellite.

In the establishing of the connection with the AMF entity, the at least one processor may further cause the first satellite to perform: determining an address of the first satellite based on an address of a gateway or an address relayed via the gateway, which is indicated by at least one of the one or more configuration update messages; and establishing a transport network layer (TNL) association with the AMF entity connected to the anchor satellite based on the address of the gateway or the address relayed via the gateway.

In the establishing of the connection with the AMF entity, the at least one processor may further cause the first satellite to perform: performing a next generation (NG) setup procedure with the AMF entity based on the TNL association.

In the establishing of the connection with the AMF entity, the at least one processor may further cause the first satellite to perform: performing a radio access network (RAN) configuration update procedure with the AMF entity based on the TNL association.

Each of the one or more configuration update messages may include at least one of: identification information of each of the one or more satellites, address information of each of the one or more satellites, identification information of a gateway connected to each of the one or more satellites, information on an address of the gateway connected to each of the one or more satellites, information on an address relayed via the gateway, identification information of an AMF entity connected to each of the one or more satellites, address information of the AMF entity connected to each of the one or more satellites, information on a hop count through an inter satellite link (ISL) between each of the one or more satellites and the first satellite, or information on traffic load through the ISL between each of the one or more satellites and the first satellite.

A hop count between the anchor satellite and the first satellite may be less than or equal to a hop count between the first satellite and at least one of the one or more satellites other than the anchor satellite.

According to the present disclosure, a first satellite may be unable to establish a connection with an AMF entity located on the ground. The first satellite may receive one or more configuration update messages from other satellites that have established connections with AMF entities through inter satellite links (ISLs). The first satellite may determine an anchor satellite among these satellites based on the received configuration update message(s). The first satellite may then establish a connection with an AMF entity connected to the anchor satellite via the anchor satellite. A terminal served through a service link of the first satellite may access the AMF entity through an ISL between the first satellite and the anchor satellite. Based on the above procedures, even when a feeder link is not established at the satellite due to movement of the satellite, the satellite can provide services to the terminal. Thus, when the satellite without a feeder link provides services to the terminal, continuous services can be maintained despite movement of the satellite or the terminal.

### BRIEF DESCRIPTION OF DRAWINGS

FIG. 1 is a conceptual diagram illustrating exemplary embodiments of a non-terrestrial network.

FIG. 2 is a conceptual diagram illustrating exemplary embodiments of a non-terrestrial network.

FIG. 3 is a block diagram illustrating exemplary embodiments of an entity constituting a non-terrestrial network.

FIG. 4 is a conceptual diagram illustrating exemplary embodiments of a non-terrestrial network including a transparent satellite.

FIG. 5 is a conceptual diagram illustrating exemplary embodiments of protocol stacks of a non-terrestrial network including a transparent satellite.

FIG. 6 is a conceptual diagram illustrating exemplary embodiments of protocol stacks of a non-terrestrial network including a transparent satellite.

FIG. 7 is a conceptual diagram illustrating exemplary embodiments of a non-terrestrial network including a regenerative satellite.

FIG. 8 is a conceptual diagram illustrating exemplary embodiments of a non-terrestrial network including regenerative satellites.

FIG. 9 is a conceptual diagram illustrating exemplary embodiments of protocol stacks of a non-terrestrial network including a regenerative satellite.

FIG. 10 is a conceptual diagram illustrating exemplary embodiments of protocol stacks of a non-terrestrial network including a regenerative satellite.

FIG. 11 is a conceptual diagram illustrating exemplary embodiments of AMF service areas.

FIGS. 12 and 13 are conceptual diagrams illustrating exemplary embodiments of a feeder link switching procedure.

FIG. 14 is a conceptual diagram illustrating exemplary embodiments of a satellite constellation.

FIG. 15 is a conceptual diagram illustrating exemplary embodiments of a configuration update procedure by an anchor satellite.

FIG. 16 is a conceptual diagram illustrating exemplary embodiments of a satellite constellation.

FIG. 17 is a sequence chart illustrating exemplary embodiments of an NG setup procedure.

FIG. 18A is a sequence chart illustrating exemplary embodiments of an NG setup procedure via an anchor satellite.

FIG. 18B is a sequence chart illustrating exemplary embodiments of an NG setup procedure via an anchor satellite.

FIG. 18C is a sequence chart illustrating exemplary embodiments of an NG setup procedure via an anchor satellite.

FIG. 18D is a sequence chart illustrating exemplary embodiments of an NG setup procedure via an anchor satellite.

FIG. 19 is a conceptual diagram illustrating exemplary embodiments of a satellite constellation.

FIGS. 20A and 20B are sequence charts illustrating exemplary embodiments of a configuration update procedure via an anchor satellite.

FIG. 21 is a conceptual diagram illustrating exemplary embodiments of a satellite constellation.

FIGS. 22A and 22B are sequence charts illustrating exemplary embodiments of a configuration update procedure via an anchor satellite.

FIG. 23 is a conceptual diagram illustrating exemplary embodiments of a satellite constellation.

FIGS. 24A to 24F are sequence charts illustrating exemplary embodiments of a RAN configuration update procedure via an anchor satellite.

FIG. 25 is a conceptual diagram illustrating exemplary embodiments of a satellite constellation.

FIGS. 26A to 26F are sequence charts illustrating exemplary embodiments of an NG setup procedure via an anchor satellite.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network (or communication system) to which exemplary embodiments according to the present disclosure are applied will be described. The communication network to which exemplary embodiments according to the present disclosure are applied is not limited to the content described below, and the exemplary embodiments according to the present disclosure can be applied to various communication networks. Here, the term ‘communication network’ may be used interchangeably with ‘communication system’. The communication network may refer to a wireless communication network, and the communication system may refer to a wireless communication system.

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, signaling may be at least one of System Information (SI) signaling (e.g. transmission of System Information Block (SIB) and/or Master Information Block (MIB)), RRC signaling (e.g. transmission of RRC parameters and/or higher-layer parameters), MAC Control Element (CE) signaling, or PHY signaling (e.g. transmission of Downlink Control Information (DCI), Uplink Control Information (UCI), and/or Sidelink Control Information (SCI).

The names of frames proposed in the present disclosure may be generalized as a first frame, a second frame, a third frame, and the like. In the present disclosure, a transmission time may refer to a start time of frame transmission and/or an end time (e.g. completion time) of frame transmission, while a reception time may refer to a start time of frame reception and/or an end time (e.g. completion time) of frame reception. The term ‘time’ may be interpreted as a time point depending on a context.

In the present disclosure, a phrase including ‘when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

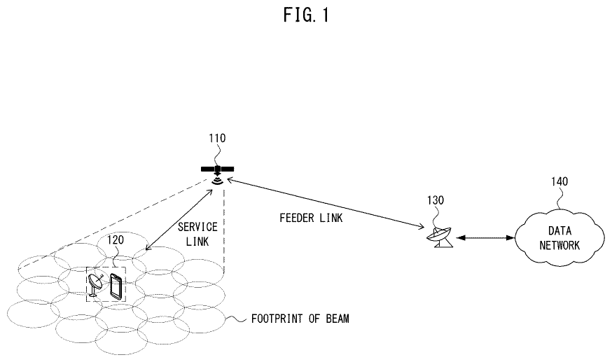

FIG. 1 is a conceptual diagram illustrating exemplary embodiments of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The satellite 110 may refer to a unmanned aerial vehicle (UAV) or a UAV base station (UBS).

The communication node 120 may include a communication node (e.g. a user equipment (UE), a terminal, or Internet of Things (IoT) device) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface. The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

A large distance between the satellite 110 and the communication node 120 may result in significantly higher propagation delay compared to terrestrial networks. If the satellite moves at high speeds, such as in the case of LEO satellite, substantial variations in propagation delay may occur. The propagation delay may depend on an elevation angle of the satellite, which is located at an altitude of 300 km to 2000 km, and may range from a minimum of 1.00 ms to 6.76 ms when the elevation angle is 90°, to a maximum of 3.87 ms to 14.78 ms when the elevation angle is 10° or 170°. The propagation delay based on the satellite's altitude and distance may be shown in Table 1 below.

TABLE 1

| | Minimum distance (elevation | | Maximum distance (elevation | |
|---|---|---|---|---|
| | angle 90) | | angle 10°or 170) | |
| | | One-way | | One-way |
| Satellite | | propagation | | propagation |
| altitude | distance | delay | distance | delay |
| (km) | (km) | (ms) | (km) | (ms) |
| 300 | 300 | 1.00 | 1160 | 3.87 |
| 600 | 600 | 2.00 | 1932 | 6.44 |
| 900 | 900 | 3.00 | 2568 | 8.56 |
| 1000 | 1000 | 3.33 | 2762 | 9.21 |
| 1200 | 1200 | 4.00 | 3131 | 10.44 |
| 1500 | 1500 | 5.00 | 3646 | 12.15 |
| 2000 | 2000 | 6.67 | 4435 | 14.78 |

Since the satellite 110 moves at a high speed, a time during which the satellite is able to provide services to a specific location on the ground may be limited. For example, an LEO satellite located at an altitude of 600 km is able to provide wireless communication service to a specific location on the ground for approximately 500 seconds.

To inform the characteristics of the high-speed moving satellite to the terminal, the base station may broadcast ephemeris information and serviceable time of the satellite 110. The 3rd generation partnership project (3GPP) specifies that the base station broadcasts the satellite's ephemeris information element and serviceable time (i.e. t-service information element) using a system information block 19 (SIB19).

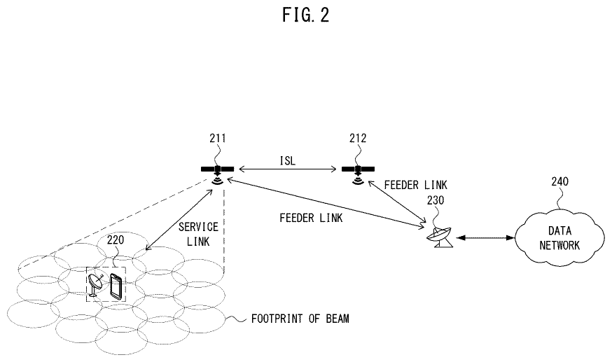

FIG. 2 is a conceptual diagram illustrating exemplary embodiments of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like.

Alternatively, the core network may exist between the gateway 230 and the data network 240. In this case, the base station implemented on the satellites 211 and 212 may be connected with the core network via the gateway 230, and the core network may be connected with the data network 240. The base station and the core network may support the NR technology. The communications between the gateway 230 and the base station implemented on the satellites 211 and 212 may be performed based on an SRI, and the communications between the base station and the core network (e.g. AMF, UPF, SMF, and the like) may be performed based on an NG-C/U interface via a relay function of the gateway 230.

Meanwhile, entities (e.g. satellites, communication nodes, gateways, etc.) constituting the NTNs shown in FIGS. 1 and 2 may be configured as follows.

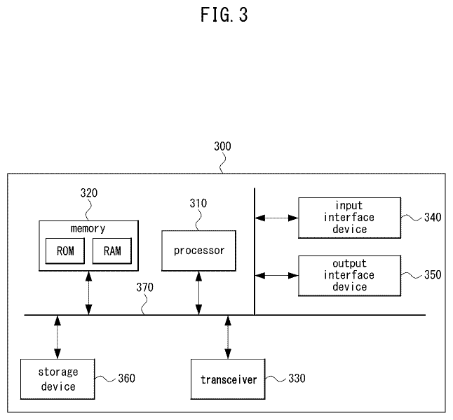

FIG. 3 is a block diagram illustrating exemplary embodiments of an entity constituting a non-terrestrial network.

Referring to FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, NTN reference scenarios may be defined as shown in Table 2 below.

TABLE 2

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’.

Parameters for the NTN reference scenarios defined in Table 2 may be defined as shown in Table 3 below.

TABLE 3

| | Scenarios A and B | | Scenarios C and D | |
|---|---|---|---|---|
| Altitude | 35,786 | km | 600 | km |
| | | | 1,200 | km |

| Spectrum (service link) | <6 GHz (e.g. 2 GHz) | | |
|---|---|---|---|
| | >6 GHz (e.g. DL 20 GHz, UL 30 GHz) | | |
| Maximum channel bandwidth | 30 MHz for band <6 GHz | | |
| capability | 1 GHz for band >6 GHz | | |
| (service link) | | | |
| Maximum distance between | 40,581 | km | 1,932 km (altitude of 600 km) |
| satellite and communication | | | 3,131 km (altitude of 1,200 km) |
| node (e.g. UE) at the minimum | | | |
| elevation angle | | | |
| Maximum round trip delay | Scenario A: 541.46 ms (service | | Scenario C: (transparent |
| (RTD) | and feeder links) | | payload: service and feeder |
| (only propagation delay) | Scenario B: 270.73 ms (only | | links) |
| | service link) | | −5.77 ms (altitude of 60 0 km) |
| | | | −41.77 ms (altitude of 1,200 |
| | | | km) |
| | | | Scenario D: (regenerative |
| | | | payload: only service link) |
| | | | −12.89 ms (altitude of 600 km) |
| | | | −20.89 ms (altitude of 1,200 |
| | | | km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |

| | |
|---|---|
| within a cell | 3.18 ms (altitude of 1,200 km) |

| | |
|---|---|
| Service link | NR defined in 3GPP |
| Feeder link | Radio interfaces defined in 3GPP or non-3GPP |

In addition, in the NTN reference scenarios defined in Table 2, delay constraints may be defined as shown in Table 4 below.

TABLE 4

| | Scenario A | Scenario B | Scenario C1-2 | | Scenario D1-2 | |
|---|---|---|---|---|---|---|
| Satellite altitude | 35,786 km | | 600 km | | | |
| Maximum RTD in a | 541.75 ms | 270.57 ms | 28.41 | ms | 12.88 | ms |
| radio interface between | (worst case) | | | | | |
| base station and UE | | | | | | |
| Minimum RTD in a | 477.14 ms | 238.57 ms | 8 | ms | 4 | ms |
| radio interface between | | | | | | |
| base station and UE | | | | | | |

Hereinafter, methods of transmitting and receiving data using a satellite group in a communication system are described. Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a terminal is described, a base station corresponding thereto may perform an operation corresponding to the operation of the terminal. Conversely, when an operation of a base station is described, a corresponding terminal may perform an operation corresponding to the operation of the base station. In a mobile communication system, a terminal may be in a radio resource control (RRC) idle mode, RRC inactive mode, or RRC connected mode, depending on its traffic activity. When the terminal is in the RRC idle mode, a core network may not possess context information of the terminal. Therefore, the terminal in the RRC idle mode may perform terminal-based mobility-related procedures, such as cell selection or cell reselection, without receiving commands from the core network.

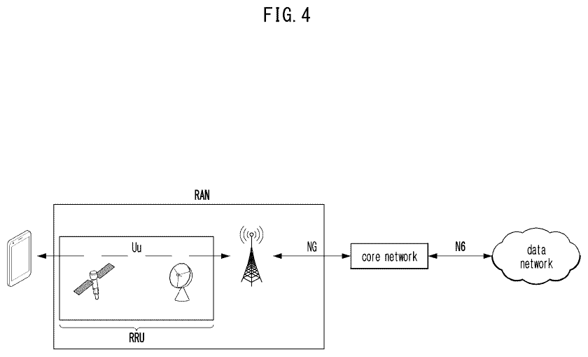

FIG. 4 is a conceptual diagram illustrating exemplary embodiments of a non-terrestrial network including a transparent satellite.

Referring to FIG. 4, a non-terrestrial network may include a terminal, a satellite, a gateway, and a base station. The satellite may be a transparent satellite. The satellite and the gateway may perform a role of a remote radio unit. A next generation (NG)-radio access network (RAN) may include the satellite, the gateway, and the base station. The base station and a core network may be connected through an NG interface. The core network and a data network may be connected through an N6 interface.

The satellite and the gateway may configure a Uu interface between the terminal and the base station. The satellite may relay the Uu interface from a feeder link to a service link. The satellite may relay the Uu interface from the service link to the feeder link. A satellite radio interface (SRI) on the feeder link may be the Uu interface. In other words, the satellite may not terminate the Uu interface. The gateway may support a function for relaying a signal transmitted through the Uu interface. A plurality of satellites may be connected to one base station.

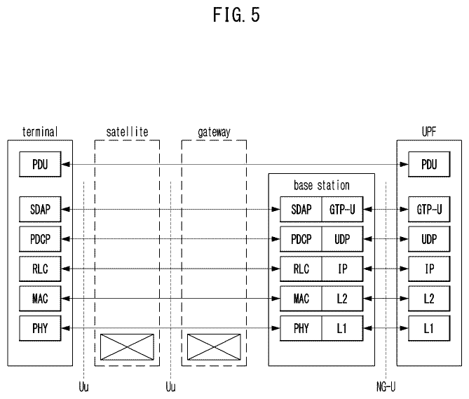

FIG. 5 is a conceptual diagram illustrating exemplary embodiments of protocol stacks of a non-terrestrial network including a transparent satellite.

Referring to FIG. 5, user plane protocol stacks of a non-terrestrial network including a transparent satellite are illustrated. Since the satellite is a transparent satellite, the satellite and a gateway may not terminate a Uu interface between a terminal and a base station. Therefore, the satellite and the gateway may not include protocol layers for transmission and reception of user data on a user plane.

In the user plane, the terminal and the base station may include service data adaptation protocol (SDAP) layers, packet data convergence protocol (PDCP) layers, radio link control (RLC) layers, medium access control (MAC) layers, and physical (PHY) layers to configure the Uu interface. In the user plane, the base station and a user plane function (UPF) entity may include GPRS tunneling protocol-user plane (GTP-U) layers, user datagram protocol (UDP) layers, layer 2 (L2) layers, and layer 1 (L1) layers to configure an NG-U interface. Protocol data units (PDUs) may be transmitted and received between the terminal and the UPF entity.

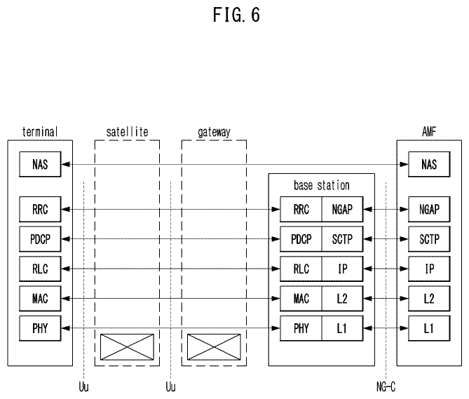

FIG. 6 is a conceptual diagram illustrating exemplary embodiments of protocol stacks of a non-terrestrial network including a transparent satellite.

Referring to FIG. 6, control plane protocol stacks of a non-terrestrial network including a transparent satellite are illustrated. Since the satellite is a transparent satellite, the satellite and a gateway may not terminate a Uu interface between a terminal and a base station. Therefore, the satellite and the gateway may not include protocol layers for transmission and reception of control data on a control plane.

In the control plane, the terminal and the base station may include RRC layers, PDCP layers, RLC layers, MAC layers, and PHY layers to configure the Uu interface. In the control plane, the base station and an access and mobility management function (AMF) entity may include next generation application protocol (NGAP) layers, stream control transmission protocol (SCTP) layers, Internet protocol (IP) layers, L2 layers, and L1 layers to configure an NG-C interface. PDUs may be transmitted and received between the terminal and the AMF entity. The terminal and the AMF entity may include non-access stratum (NAS) layers for establishment of PDU sessions.

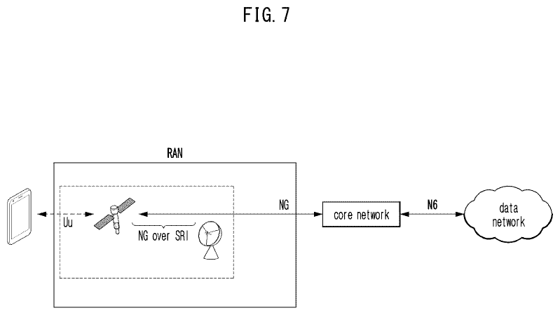

FIG. 7 is a conceptual diagram illustrating exemplary embodiments of a non-terrestrial network including a regenerative satellite.

Referring to FIG. 7, a non-terrestrial network may include a terminal, a satellite, a gateway, and a base station. The satellite may be a regenerative satellite. The satellite may perform regeneration of signals received from the ground. An NG interface may include an SRI between the satellite and the gateway. An NG-RAN may include the satellite and the gateway. The satellite and a core network may be connected through an NG interface. The core network and a data network may be connected through an N6 interface. A service link between the satellite and a terminal may be configured as a Uu interface.

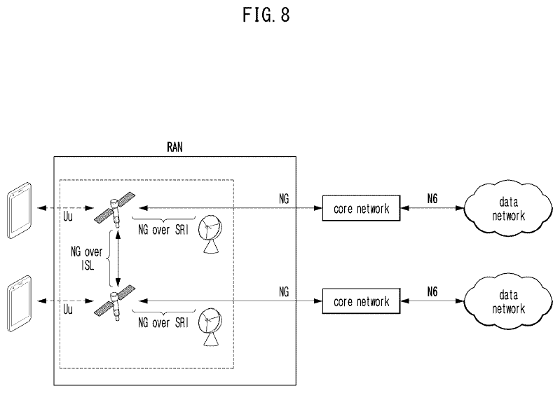

FIG. 8 is a conceptual diagram illustrating exemplary embodiments of a non-terrestrial network including regenerative satellites.

Referring to FIG. 8, a non-terrestrial network may include one or more terminals, one or more satellites, and one or more gateways. The one or more satellites may be regenerative satellites. The one or more satellites may perform regeneration of signals received from the ground. An NG interface may include an SRI between the satellite and the gateway. An NG-RAN may include the satellites and the gateways. The satellite and a core network may be connected through an NG interface. The core network and a data network may be connected through an N6 interface. A service link between the satellite and the terminal may be configured as a Uu interface. The one or more satellites may be connected to each other through ISLs. An Xn interface may be configured between the one or more satellites.

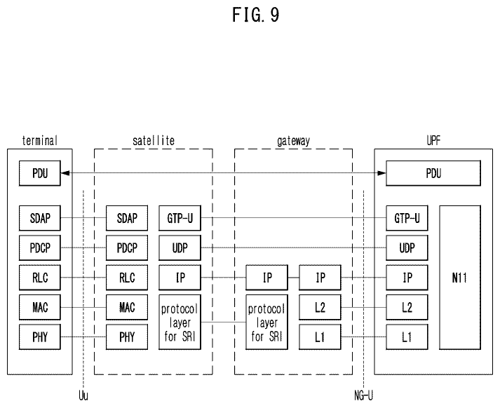

FIG. 9 is a conceptual diagram illustrating exemplary embodiments of protocol stacks of a non-terrestrial network including a regenerative satellite.

Referring to FIG. 9, user plane protocol stacks of a non-terrestrial network including a regenerative satellite are illustrated. Since the satellite is a regenerative satellite, the satellite and a gateway may include protocol layers for transmission and reception of user data on a user plane. Since the gateway is a transport network layer node, the gateway may not include layers located above an IP layer.

In the user plane, the terminal and the satellite may include SDAP layers, PDCP layers, RLC layers, MAC layers, and PHY layers to configure a Uu interface. In the user plane, the satellite and the base station may include IP layers and protocol layers for SRI. In the user plane, the satellite and a UPF entity may include GTP-U layers and UDP layers to configure an NG-U interface. In the user plane, the gateway and the UPF entity may include IP layers, L2 layers, and L1 layers to configure an NG-U interface. PDUs may be transmitted and received between the terminal and the UPF entity. The UPF entity may include protocol layers to configure an N11 interface.

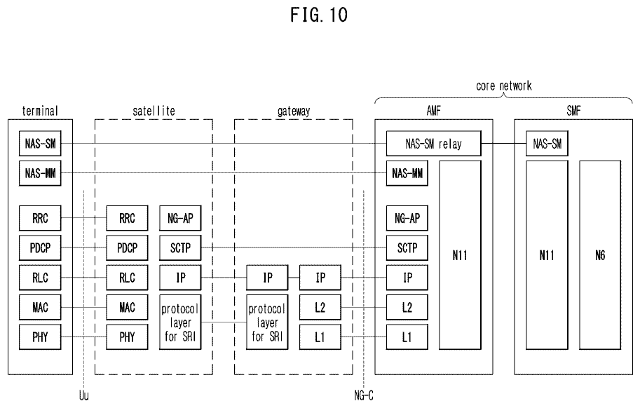

FIG. 10 is a conceptual diagram illustrating exemplary embodiments of protocol stacks of a non-terrestrial network including a regenerative satellite.

Referring to FIG. 10, control plane protocol stacks of a non-terrestrial network including a regenerative satellite are illustrated. Since the satellite is a regenerative satellite, the satellite and a gateway may include protocol layers for transmission and reception of control data on a control plane. Since the gateway is a transport network layer node, the gateway may not include layers located above an IP layer.

In the control plane, a terminal, an AMF entity, and a service management function (SMF) entity may include a non-access stratum-session management (NAS-SM) layer, a NAS-SM relay layer, and a NAS-mobility management (MM) layer, respectively. The terminal and the satellite may include RRC layers, PDCP layers, RLC layers, MAC layers, and PHY layers to configure a Uu interface. To configure the NG-C interface, the satellite, the gateway, and the AMF entity may include NG-AP layers, SCTP layers, and IP layers. The satellite and the gateway may include protocol layers to configure an SRI. The gateway and the AMF entity may include L2 layers and L1 layers to configure an NG-C interface. The AMF entity and the SMF entity may include protocol layers to configure an N11 interface. The SMF entity may include protocol layers to configure an N6 interface.

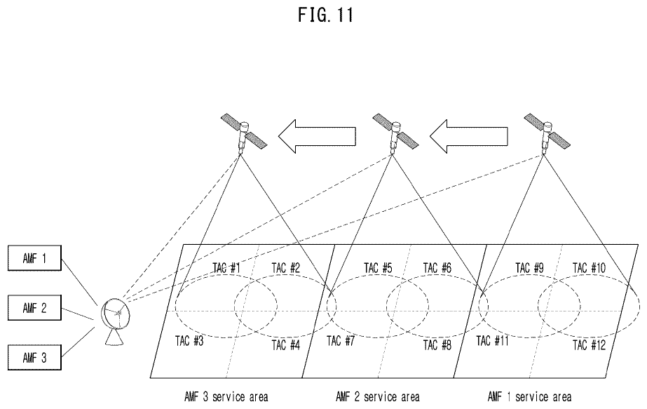

Satellites illustrated in FIG. 11 to FIG. 26F may be regenerative satellites.

FIG. 11 is a conceptual diagram illustrating exemplary embodiments of AMF service areas.

Referring to FIG. 11, a terrestrial area may include a service area of AMF 1, a service area of AMF 2, and a service area of AMF 3. Each of the AMF service areas may be fixed on the ground. Each of the AMF service areas may include tracking areas indicated by tracking area codes (TACs). A satellite may be a regenerative satellite. The satellite may move in the sky. A coverage area of the satellite may vary according to movement of the satellite. A terminal belonging to the service area of AMF 1 may be connected to the satellite through a service link. According to the movement of the satellite, a terminal belonging to the service area of AMF 2 may be connected to the satellite through a service link. According to the movement of the satellite, a terminal belonging to the service area of AMF 3 may be connected to the satellite through a service link.

The satellite may be connected to AMF 1, AMF 2, or AMF 3 via a gateway located on the ground. When the satellite provides services to the terminal belonging to the service area of AMF 1, the satellite may establish a connection with AMF 1. When the satellite provides services to the terminal belonging to the service area of AMF 2, the satellite may establish a connection with AMF 2. When the satellite provides services to the terminal belonging to the service area of AMF 3, the satellite may establish a connection with AMF 3. When the satellite enters a service area of an AMF, an NG interface establishment or update procedure may be performed. In the present disclosure, the NG interface establishment procedure may refer to NG setup, and the NG interface update procedure may refer to a radio access network (RAN) configuration update procedure. The NG setup may be performed to establish a connection with a new AMF entity rather than the previously connected AMF entity. The RAN configuration update procedure may be performed to establish a connection with the previously connected AMF through a gateway different from the previously connected gateway.

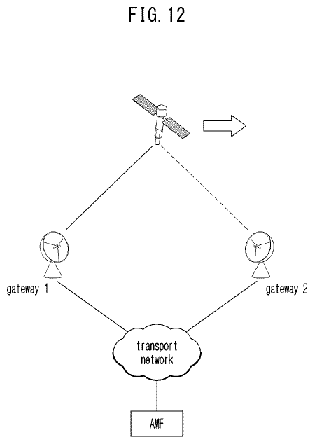

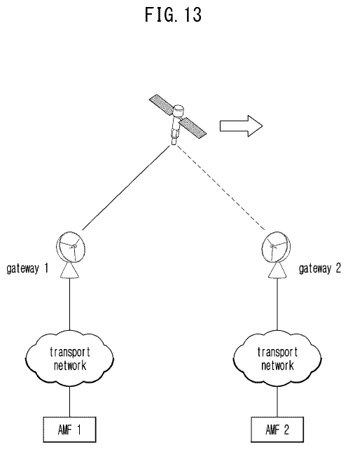

FIGS. 12 and 13 are conceptual diagrams illustrating exemplary embodiments of a feeder link switching procedure.

Referring to FIG. 12, a satellite may be connected to gateway 1 through a feeder link. The satellite may move across the sky toward a direction in which gateway 2 is located. According to the movement of the satellite, the feeder link connected to the satellite may be switched. According to the switching of the feeder link, the satellite may be connected to gateway 2 through the feeder link. Gateway 1 and gateway 2 may be connected to the same AMF entity via a transport network. Therefore, the AMF entity connected with the satellite after the switching of the feeder link may remain the same.

Referring to FIG. 13, a satellite may be connected to gateway 1 through a feeder link. The satellite may move across the sky toward a direction in which gateway 2 is located. According to the movement of the satellite, the feeder link connected to the satellite may be switched. According to the switching of the feeder link, the satellite may be connected to gateway 2 through the feeder link. Gateway 1 and gateway 2 may be connected to different AMF entities (e.g. AMF 1 or AMF 2) via transport networks. Therefore, AMF entity 2 connected with the satellite after the switching of the feeder link may be different from AMF entity 1 connected with the satellite before the switching of the feeder link.

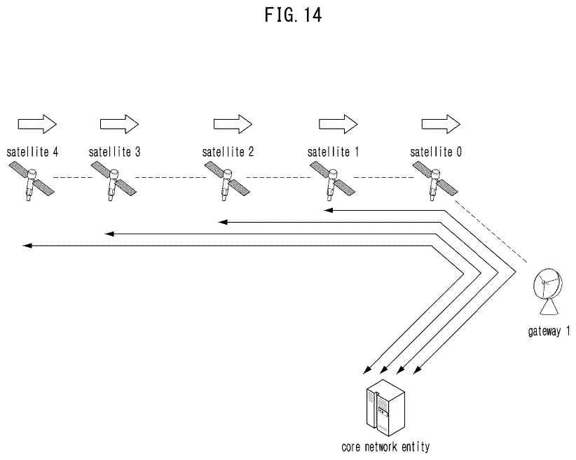

In exemplary embodiments illustrated in FIG. 14 to FIG. 26F, the following assumptions may be made. Satellites may be regenerative satellites. One satellite constellation may include satellites. Satellites belonging to one satellite constellation may transmit and receive user data or control signals through ISLs. One or more satellites belonging to one satellite constellation may establish feeder link(s) with gateway(s) located on the ground. One or more satellites that establish feeder link(s) with gateway(s) may establish connection(s) with AMF entity(ies) located on the ground through NG setup via the feeder link(s). Satellites that do not establish feeder links with the gateway(s) may be connected through ISLs with the satellite(s) that establish the feeder link(s). Satellites that do not establish feeder links may be connected to the gateway(s) and the AMF entity (ies) through an anchor function of the satellite(s) that establish the feeder link(s).

FIG. 14 is a conceptual diagram illustrating exemplary embodiments of a satellite constellation.

Referring to FIG. 14, a non-terrestrial network may include satellites 0 to 4, a gateway, and a core network entity (e.g. AMF entity 1). A satellite constellation may include satellites 0 to 4. Satellite 0 may be connected to AMF entity 1 through a feeder link. Satellites 1 to 4 may not be connected to the gateway through feeder links. Satellites 1 to 4 may be connected to AMF entity 1 through ISLs. A terminal served by satellites 1 to 4 may be connected to AMF entity 1 through the ISLs. Satellites 1 to 4 may provide services to the terminal through an establishment or update procedure (e.g. NG setup or RAN configuration update) of the NG interface in a situation without a feeder link.

Satellite 0 may perform switching of the feeder link while moving in the sky. Satellite 0 may establish a feeder link with gateway 1 through the switching of the feeder link. Satellite 0 that establishes the feeder link may receive first information from gateway 1. The first information may include at least one of information of an address of gateway 1, information of an address relayed via gateway 1 (e.g. IP address or transport network layer (TNL) address), or information of an address of AMF entity 1 (e.g. IP address or TNL address).

When the AMF entity connected with satellite 0 before the switching of the feeder link is AMF entity 1, satellite 0 may perform an RAN configuration update. Alternatively, when the AMF entity connected with satellite 0 before the switching of the feeder link is not AMF entity 1, satellite 0 may establish a connection with AMF entity 1 through NG setup via gateway 1. After establishing the connection with AMF entity 1, satellite 0 may operate as an anchor satellite.

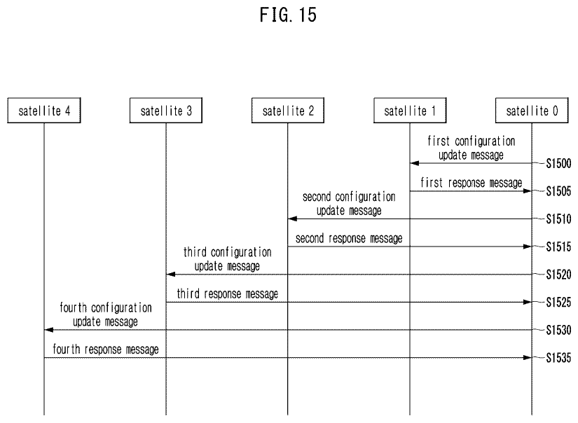

FIG. 15 is a conceptual diagram illustrating exemplary embodiments of a configuration update procedure by an anchor satellite.

Referring to FIG. 15, satellites 0 to 4 illustrated in FIG. 15 may be the same as satellites 0 to 4 illustrated in FIG. 14. A procedure according to exemplary embodiments illustrated in FIG. 15 may be performed after satellite 0 establishes a connection with an AMF entity connected with gateway 1 according to exemplary embodiments illustrated in FIG. 14.

Satellite 0 that establishes the connection with the AMF entity may transmit configuration update messages to satellites 1 to 4 through ISLs. The configuration update message may be an XnAP message (e.g. an NG configuration update message or an NG-RAN node configuration update message). The configuration update message may include at least one of identification information of an anchor satellite (e.g. satellite 0), address information of the anchor satellite (e.g. information of an IP address or TNL address), identification information of a gateway connected with the anchor satellite through the feeder link, information of an address of the gateway connected with the anchor satellite through the feeder link, information of an address relayed via the gateway (e.g. information of an IP address or TNL address), identification information of an AMF entity connected with the anchor satellite, address information of the AMF entity connected with the anchor satellite (e.g. information of an IP address or TNL address), information of an integrated number of hops of the ISL between the anchor satellite and a satellite receiving the configuration update (hereinafter referred to as ‘ISL hops’), or information of traffic load between the anchor satellite and the satellite that receives the configuration update message. According to exemplary embodiments illustrated in FIG. 15 to FIG. 26F, the configuration update message may include the above-described information elements.

Hereinafter, a procedure in which satellite 0 transmits the configuration update messages to satellites 1 to 4 is described. A sequence in which satellite 0 transmits a first configuration update message to a fourth configuration update message to satellites 1 to 4 may be changed with each other.

Satellite 0 may transmit a first configuration update message to satellite 1 (S1500). The first configuration update message may be an XnAP message. The first configuration update message may include at least one of identification information of satellite 0, address information of satellite 0, identification information of gateway 1, information of an address of gateway 1, information of an address relayed via gateway 1, identification information of AMF entity 1, address information of AMF entity 1, information of ISL hops between satellite 0 and satellite 1, or information of traffic load between satellite 0 and satellite 1.

Satellite 1 that receives the first configuration update message may identify that satellite 0 is the anchor satellite based on the first configuration update message. Satellite 1 may identify identification information of gateway 1, information of the address of gateway 1, information of the address relayed via gateway 1, or identification information/address information of AMF entity 1 based on the first configuration update message. Satellite 1 may determine whether to establish a TNL association (or SCTP association) with AMF entity 1 anchored by gateway 1 based on at least one of information of ISL hops or information of traffic load indicated by the first configuration update message. When it is determined to establish a TNL association with AMF entity 1, satellite 1 may transmit a first response message, which is an ACK message, to satellite 0 (S1505). When it is determined to establish a TNL association with AMF entity 1, satellite 1 may change (or determine) its own address according to information of the address of gateway 1 or information of the address relayed via gateway 1. Satellite 1 that changes its own address may establish a TNL association with AMF entity 1 based on the changed address. Satellite 1 may perform NG setup with AMF entity 1 based on the established TNL association.

In another example, the first response message may be transmitted to satellite 0 regardless of the determination on whether to establish a TNL association with AMF entity 1. The first response message may indicate whether the first configuration update message has been received. Transmission of the first response message may be performed to satellite 0 before the determination on whether to establish the TNL association with AMF entity 1 is made.

Satellite 0 may transmit a second configuration update message to satellite 2 (S1510). The second configuration update message may be an XnAP message. The second configuration update message may include at least one of identification information of satellite 0, address information of satellite 0, identification information of gateway 1, information of the address of gateway 1, information of an address relayed via gateway 1, identification information of AMF entity 1, address information of AMF entity 1, information of ISL hops between satellite 0 and satellite 2, or information of traffic load between satellite 0 and satellite 2.

Satellite 2 that receives the second configuration update message may identify that satellite 0 is the anchor satellite based on the second configuration update message. Satellite 2 may identify at least one of identification information of gateway 1, information of the address of gateway 1, information of the address relayed via gateway 1, or identification information/address information of AMF entity 1 based on the second configuration update message. Satellite 2 may determine whether to establish a TNL association (or SCTP association) with AMF entity 1 anchored by gateway 1 based on at least one of information of ISL hops or information of traffic load indicated by the second configuration update message. When it is determined to establish a TNL association with AMF entity 1, satellite 2 may transmit a second response message, which is an ACK message, to satellite 0 (S1515). When it is determined to establish a TNL association with AMF entity 1, satellite 2 may change (or determine) its own address according to information of the address of gateway 1 or information of the address relayed via gateway 1. Satellite 2 that changes its own address may establish the TNL association with AMF entity 1 based on the changed address. Satellite 2 may perform NG setup with AMF entity 1 based on the established TNL association.

In another example, the second response message may be transmitted to satellite 0 regardless of the determination on whether to establish a TNL association with AMF entity 1. The second response message may indicate whether the second configuration update message has been received. Transmission of the second response message may be performed to satellite 0 before the determination on whether to establish the TNL association with AMF entity 1 is made.

Satellite 0 may transmit a third configuration update message to satellite 3 (S1520). The third configuration update message may be an XnAP message. The third configuration update message may include at least one of identification information of satellite 0, address information of satellite 0, identification information of gateway 1, information of the address of gateway 1, information of an address relayed via gateway 1, identification information of AMF entity 1, address information of AMF entity 1, information of ISL hops between satellite 0 and satellite 3, or information of traffic load between satellite 0 and satellite 3.

Satellite 3 that receives the third configuration update message may identify that satellite 0 is the anchor satellite based on the third configuration update message. Satellite 3 may identify at least one of identification information of gateway 1, information of the address of gateway 1, information of the address relayed via gateway 1, or identification information/address information of AMF entity 1 based on the third configuration update message. Satellite 3 may determine whether to establish a TNL association (or SCTP association) with AMF entity 1 anchored by gateway 1 based on at least one of information of ISL hops or information of traffic load indicated by the third configuration update message. When it is determined to establish a TNL association with AMF entity 1, satellite 3 may transmit a third response message, which is an ACK message, to satellite 0 (S1525). When it is determined to establish a TNL association with AMF entity 1, satellite 3 may change (or determine) its own address according to information of the address of gateway 1 or information of the address relayed via gateway 1. Satellite 3 that changes its own address may establish the TNL association with AMF entity 1 based on the changed address. Satellite 3 may perform NG setup with AMF entity 1 based on the established TNL association.

In another example, the third response message may be transmitted to satellite 0 regardless of the determination on whether to establish a TNL association with AMF entity 1. The third response message may indicate whether the third configuration update message has been received. Transmission of the third response message may be performed to satellite 0 before the determination on whether to establish the TNL association with AMF entity 1 is made.

Satellite 0 may transmit a fourth configuration update message to satellite 4 (S1530). The fourth configuration update message may be an XnAP message. The fourth configuration update message may include at least one of identification information of satellite 0, address information of satellite 0, identification information of gateway 1, information of the address of gateway 1, information of an address relayed via gateway 1, identification information of AMF entity 1, address information of AMF entity 1, information of ISL hops between satellite 0 and satellite 4, or information of traffic load between satellite 0 and satellite 4.

Satellite 4 that receives the fourth configuration update message may identify that satellite 0 is the anchor satellite based on the fourth configuration update message. Satellite 4 may identify at least one of identification information of gateway 1, information of the address of gateway 1, information of the address relayed via gateway 1, or identification information/address information of AMF entity 1 based on the fourth configuration update message. Satellite 4 may determine whether to establish a TNL association (or SCTP association) with AMF entity 1 anchored by gateway 1 based on at least one of information of ISL hops or information of traffic load indicated by the fourth configuration update message. When it is determined to establish a TNL association with AMF entity 1, satellite 4 may transmit a fourth response message, which is an ACK message, to satellite 0 (S1535). When it is determined to establish a TNL association with AMF entity 1, satellite 4 may change (or determine) its own address according to information of the address of gateway 1 or information of the address relayed via gateway 1. Satellite 4 that changes its own address may establish the TNL association with AMF entity 1 based on the changed address. Satellite 4 may perform NG setup with AMF entity 1 based on the established TNL association.

In another example, the fourth response message may be transmitted to satellite 0 regardless of the determination on whether to establish a TNL association with AMF entity 1. The fourth response message may indicate whether the fourth configuration update message has been received. Transmission of the fourth response message may be performed to satellite 0 before the determination on whether to establish the TNL association with AMF entity 1 is made.

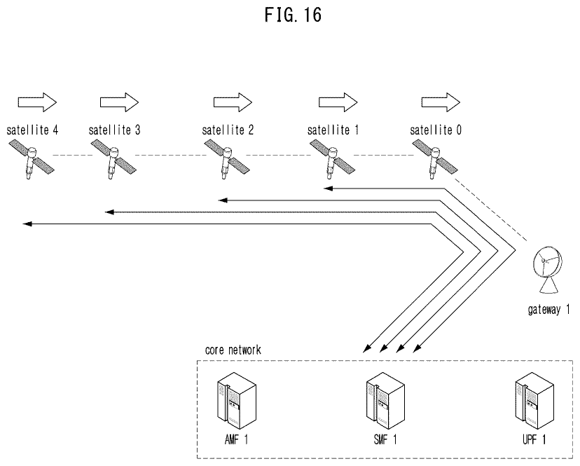

The exemplary embodiments illustrated in FIG. 14 and FIG. 15 may be applied to exemplary embodiments illustrated in FIG. 16 to FIG. 26F.

FIG. 16 is a conceptual diagram illustrating exemplary embodiments of a satellite constellation.

Referring to FIG. 16, a satellite constellation may include satellites 0 to 4. Satellites 0 to 4 may be connected to each other through ISLs. Satellites 0 to 4 may move across the sky toward a direction in which gateway 1 is located. Satellites 0 to 4 may form coverage areas in a service area of AMF entity 1.

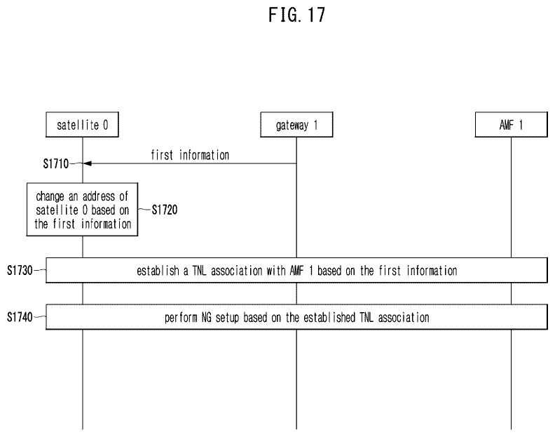

A procedure according to exemplary embodiments illustrated in FIG. 17 may be performed after a situation according to exemplary embodiments illustrated in FIG. 16 occurs.

FIG. 17 is a sequence chart illustrating exemplary embodiments of an NG setup procedure.

Referring to FIG. 17, satellite 0 may enter a service area of gateway 1. Satellite 0 that enters the service area of gateway 1 may establish a feeder link with gateway 1. Satellite 0 that establishes the feeder link with gateway 1 may receive first information including at least one of information of an address of gateway 1, information of an address relayed via gateway 1 (e.g. information of an IP address or TNL address of gateway 1), or address information of AMF entity 1 (e.g. information of an IP address or TNL address of AMF entity 1) from gateway 1 (S1710). Satellite 0 that receives the first information may change (or determine) its own address according to the address of gateway 1 or the address relayed via gateway 1 (S1720). Based on the changed address, satellite 0 may establish a TNL association (or SCTP association) with AMF entity 1 (S1730). Satellite 0 may perform NG setup with AMF entity 1 based on the established TNL association (S1740). Satellite 0 that completes the NG setup may operate as an anchor satellite.

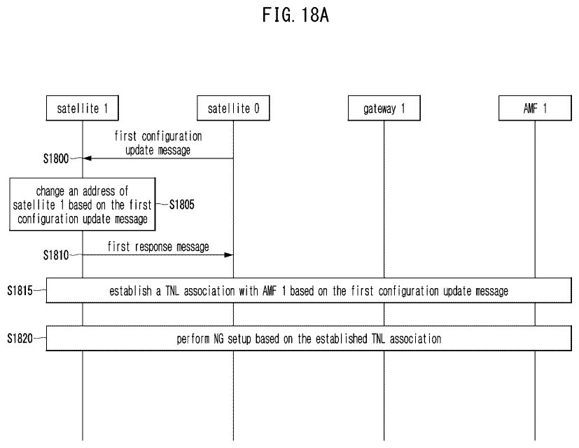

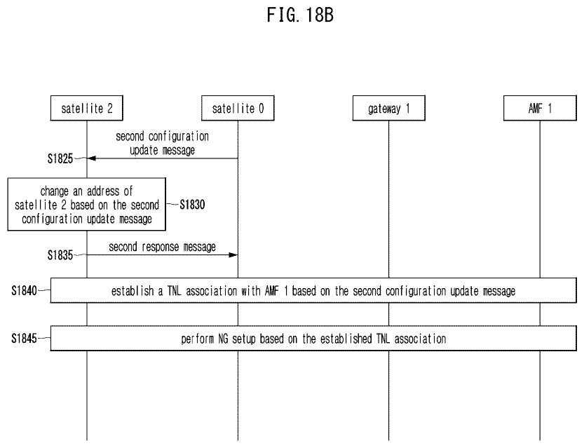

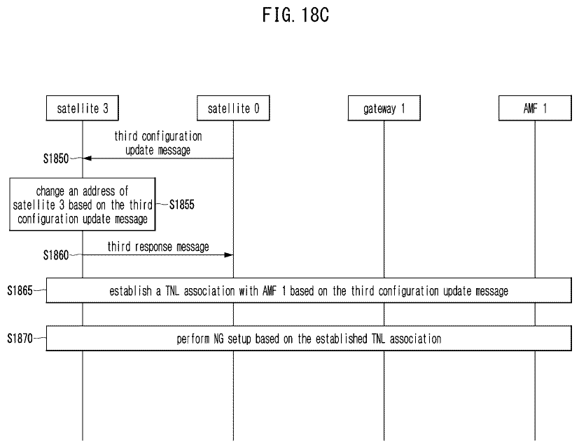

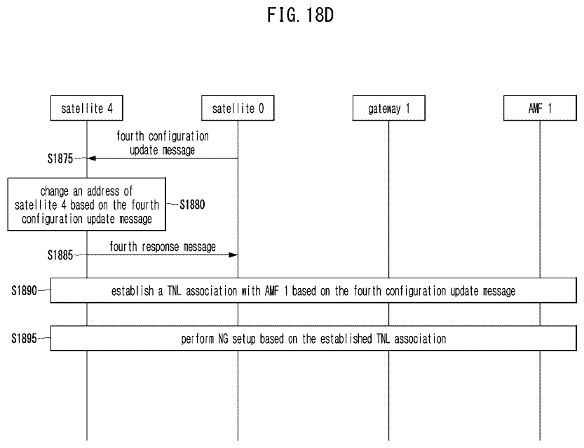

A procedure according to exemplary embodiments illustrated in FIG. 18A may be performed after the procedure according to exemplary embodiments illustrated in FIG. 17 is completed.

FIG. 18A is a sequence chart illustrating exemplary embodiments of an NG setup procedure via an anchor satellite.

Referring to FIG. 18A, satellite 0 may transmit a first configuration update message to satellite 1 (S1800). Satellite 1 that receives the first configuration update message may identify satellite 0 as an anchor satellite based on the first configuration update message. Satellite 1 may determine whether to establish a connection with AMF entity 1 based on the first configuration update message. Satellite 1 that determines to establish a connection with AMF entity 1 may change its own address based on an address of gateway 1 or an address relayed via gateway 1 indicated by the first configuration update message (S1805). Satellite 1 that changes its own address may transmit a first response message to satellite 0 (S1810). After transmitting the first response message, satellite 1 may establish a TNL association with AMF entity 1 based on the changed address (S1815). The established TNL association may be anchored by gateway 1. Based on the established TNL association, satellite 1 may perform NG setup with AMF entity 1 (S1820).

FIG. 18B is a sequence chart illustrating exemplary embodiments of an NG setup procedure via an anchor satellite.

Referring to FIG. 18B, satellite 0 may transmit a second configuration update message to satellite 2 (S1825). Satellite 2 that receives the second configuration update message may identify satellite 0 as the anchor satellite based on the second configuration update message. Satellite 2 may determine whether to establish a connection with AMF entity 1 based on the second configuration update message. Satellite 2 that determines to establish a connection with AMF entity 1 may change its own address based on the address of gateway 1 or the address relayed via gateway 1 indicated by the second configuration update message (S1830). Satellite 2 that changes its own address may transmit a second response message to satellite 0 (S1835). After transmitting the second response message, satellite 2 may establish a TNL association with AMF entity 1 based on the changed address (S1840). The established TNL association may be anchored by gateway 1. Based on the established TNL association, satellite 2 may perform NG setup with AMF entity 1 (S1845).

FIG. 18C is a sequence chart illustrating exemplary embodiments of an NG setup procedure via an anchor satellite.

Referring to FIG. 18C, satellite 0 may transmit a third configuration update message to satellite 3 (S1850). Satellite 3 receiving the third configuration update message may identify satellite 0 as the anchor satellite based on the third configuration update message. Satellite 3 may determine whether to establish a connection with AMF entity 1 based on the third configuration update message. Satellite 3 that determines to establish a connection with AMF entity 1 may change its own address based on the address of gateway 1 or the address relayed via gateway 1 indicated by the third configuration update message (S1855). Satellite 3 that changes its own address may transmit a third response message to satellite 0 (S1860). After transmitting the third response message, satellite 3 may establish a TNL association with AMF entity 1 based on the changed address (S1865). The established TNL association may be anchored by gateway 1. Based on the established TNL association, satellite 3 may perform NG setup with AMF entity 1 (S1870).

FIG. 18D is a sequence chart illustrating exemplary embodiments of an NG setup procedure via an anchor satellite.

Referring to FIG. 18D, satellite 0 may transmit a fourth configuration update message to satellite 4 (S1875). Satellite 4 that receives the fourth configuration update message may identify satellite 0 as the anchor satellite based on the fourth configuration update message. Satellite 4 may determine whether to establish a connection with AMF entity 1 based on the fourth configuration update message. Satellite 4 that determines to establish a connection with AMF entity 1 may change its own address based on the address of gateway 1 or the address relayed via gateway 1 indicated by the fourth configuration update message (S1880). Satellite 4 that changes its own address may transmit a fourth response message to satellite 0 (S1885). After transmitting the fourth response message, satellite 4 may establish a TNL association with AMF entity 1 based on the changed address (S1890). The established TNL association may be anchored by gateway 1. Based on the established TNL association, satellite 4 may perform NG setup with AMF entity 1 (S1895).

A situation according to exemplary embodiments illustrated in FIG. 19 may occur after the procedure according to exemplary embodiments illustrated in FIG. 18D is completed.

FIG. 19 is a conceptual diagram illustrating exemplary embodiments of a satellite constellation.

Referring to FIG. 19, a satellite constellation may include satellite 0 to satellite 4. Satellite 0 to satellite 4 may be connected to one another through ISLs. Satellite 1 to satellite 4 may move across the sky toward a direction in which gateway 1 is located. Satellite 0 to satellite 4 may form coverage areas in a service area of AMF entity 1. Satellite 1 may enter a service area of gateway 1. Satellite 0 may leave the service area of gateway 1. Satellite 0 may release a feeder link with gateway 1. Satellite 1 that enters the service area of gateway 1 may establish a feeder link with gateway 1.

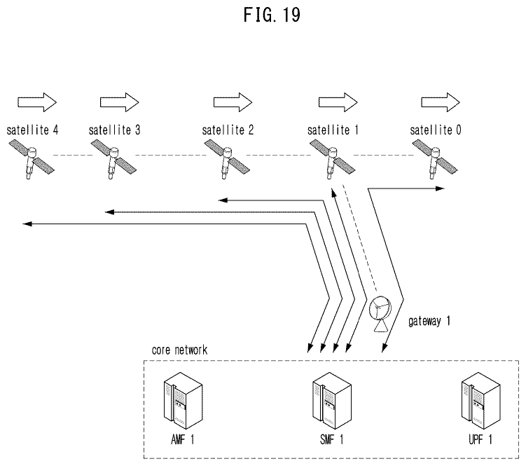

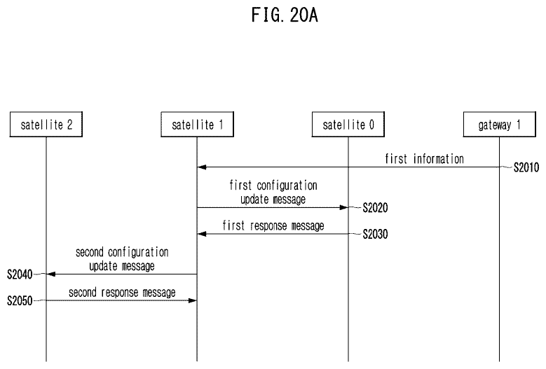

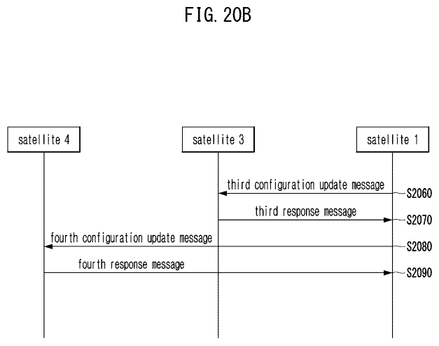

Procedures according to exemplary embodiments illustrated in FIGS. 20A and 20B may be performed after the situation according to exemplary embodiments illustrated in FIG. 19 occurs.

FIGS. 20A and 20B are sequence charts illustrating exemplary embodiments of a configuration update procedure via an anchor satellite.

Referring to FIG. 20A, satellite 1 that establishes a feeder link with gateway 1 may receive first information including at least one of information of an address of gateway 1, information of an address relayed via gateway 1 (e.g. information of an IP address or TNL address of gateway 1), or address information of AMF entity 1 (e.g. information of an IP address or TNL address of AMF entity 1) from gateway 1 (S2010). Satellite 1 that receives the first information may identify that the address of gateway 1 or the address relayed via gateway 1 is the same as its own address. Without establishment of a TNL association or NG setup, satellite 1 may operate as an anchor satellite.

Satellite 1 operating as the anchor satellite may transmit a first configuration update message to satellite 0 (S2020). After receiving the first configuration update message, satellite 0 may identify satellite 1 as the anchor satellite. Satellite 0 may establish an NG interface with AMF entity 1 through the anchor operation of satellite 1 without establishment of a TNL association or NG setup. Satellite 0 that establishes the NG interface may transmit a first response message to satellite 1 (S2030). The first response message may be transmitted before establishment of the NG interface. Satellite 1 may receive the first response message from satellite 0.

Satellite 1 operating as the anchor satellite may transmit a second configuration update message to satellite 2 (S2040). After receiving the second configuration update message, satellite 2 may identify satellite 1 as the anchor satellite. Satellite 2 may establish an NG interface with AMF entity 1 through the anchor operation of satellite 1 without establishment of a TNL association or NG setup. Satellite 2 that establishes the NG interface may transmit a second response message to satellite 1 (S2050). The second response message may be transmitted before establishment of the NG interface. Satellite 1 may receive the second response message from satellite 2.

Referring to FIG. 20B, satellite 1 operating as the anchor satellite may transmit a third configuration update message to satellite 3 (S2060). After receiving the third configuration update message, satellite 3 may identify satellite 1 as the anchor satellite. Satellite 3 may establish an NG interface with AMF entity 1 through the anchor operation of satellite 1 without establishment of a TNL association or NG setup. Satellite 3 that establishes the NG interface may transmit a third response message to satellite 1 (S2070). The third response message may be transmitted before establishment of the NG interface. Satellite 1 may receive the third response message from satellite 3.

Satellite 1 operating as the anchor satellite may transmit a fourth configuration update message to satellite 4 (S2080). After receiving the fourth configuration update message, satellite 4 may identify satellite 1 as the anchor satellite. Satellite 4 may establish an NG interface with AMF entity 1 through the anchor operation of satellite 1 without establishment of a TNL association or NG setup. Satellite 4 that establishes the NG interface may transmit a fourth response message to satellite 1 (S2090). The fourth response message may be transmitted before establishment of the NG interface. Satellite 1 may receive the fourth response message from satellite 4.

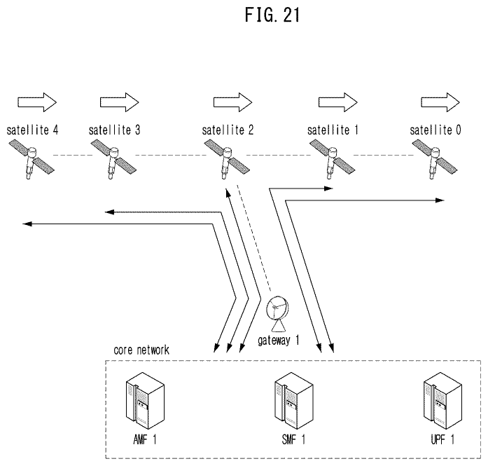

A situation according to exemplary embodiments illustrated in FIG. 21 may occur after the procedure according to exemplary embodiments illustrated in FIG. 20B is completed.

FIG. 21 is a conceptual diagram illustrating exemplary embodiments of a satellite constellation.

Referring to FIG. 21, a satellite constellation may include satellite 0 to satellite 4. Satellite 0 to satellite 4 may be connected to one another through ISLs. Satellite 2 to satellite 4 may move across the sky toward a direction in which gateway 1 is located. Satellite 0 to satellite 4 may form coverage areas in a service area of AMF entity 1. Satellite 2 may enter a service area of gateway 1. Satellite 1 may leave the service area of gateway 1. Satellite 1 may release a feeder link with gateway 1. Satellite 2 entering the service area of gateway 1 may establish a feeder link with gateway 1.

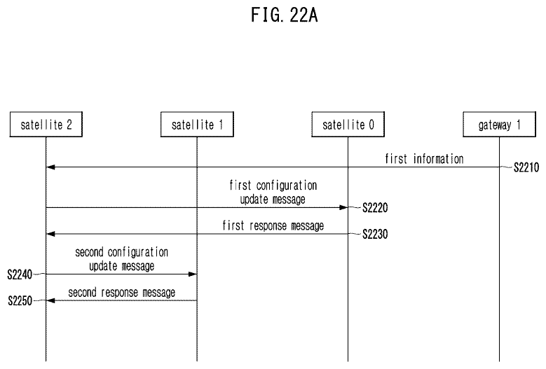

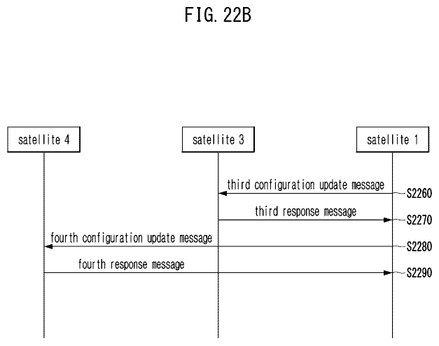

A procedure according to exemplary embodiments illustrated in FIGS. 22A and 22B may be performed after the situation according to exemplary embodiments illustrated in FIG. 21 occurs.

FIGS. 22A and 22B are sequence charts illustrating exemplary embodiments of a configuration update procedure via an anchor satellite.

Referring to FIG. 22A, satellite 2 that establishes a feeder link with gateway 1 may receive first information including at least one of information of an address of gateway 1, information of an address relayed via gateway 1 (e.g. information of an IP address or TNL address of gateway 1), or address information of AMF entity 1 (e.g. information of an IP address or TNL address of AMF entity 1) from gateway 1 (S2210). Satellite 2 that receives the first information may identify that the address of gateway 1 or the address relayed via gateway 1 is the same as its own address. Without establishment of a TNL association or NG setup, satellite 2 may operate as an anchor satellite.

Satellite 2 operating as the anchor satellite may transmit a first configuration update message to satellite 0 (S2220). After receiving the first configuration update message, satellite 0 may identify satellite 2 as the anchor satellite. Satellite 0 may establish an NG interface with AMF entity 1 through the anchor operation of satellite 2 without establishment of a TNL association or NG setup. Satellite 0 that establishes the NG interface may transmit a first response message to satellite 2 (S2230). The first response message may be transmitted before establishment of the NG interface. Satellite 2 may receive the first response message from satellite 0.

Satellite 2 operating as the anchor satellite may transmit a second configuration update message to satellite 1 (S2240). After receiving the second configuration update message, satellite 1 may identify satellite 2 as the anchor satellite. Satellite 1 may establish an NG interface with AMF entity 1 through the anchor operation of satellite 2 without establishment of a TNL association or NG setup. Satellite 1 that establishes the NG interface may transmit a second response message to satellite 2 (S2250). The second response message may be transmitted before establishment of the NG interface. Satellite 2 may receive the second response message from satellite 1.

Referring to FIG. 22B, satellite 2 operating as the anchor satellite may transmit a third configuration update message to satellite 3 (S2260). After receiving the third configuration update message, satellite 3 may identify satellite 2 as the anchor satellite. Satellite 3 may establish an NG interface with AMF entity 1 through the anchor operation of satellite 2 without establishment of a TNL association or NG setup. Satellite 3 that establishes the NG interface may transmit a third response message to satellite 2 (S2270). The third response message may be transmitted before establishment of the NG interface. Satellite 2 may receive the third response message from satellite 3.

Satellite 2 operating as the anchor satellite may transmit a fourth configuration update message to satellite 4 (S2280). After receiving the fourth configuration update message, satellite 4 may identify satellite 2 as the anchor satellite. Satellite 4 may establish an NG interface with AMF entity 1 through the anchor operation of satellite 2 without establishment of a TNL association or NG setup. Satellite 4 that establishes the NG interface may transmit a fourth response message to satellite 2 (S2290). The fourth response message may be transmitted before establishment of the NG interface. Satellite 2 may receive the fourth response message from satellite 4.

A situation according to exemplary embodiments illustrated in FIG. 23 may occur after the procedure according to exemplary embodiments illustrated in FIG. 22B is completed.

FIG. 23 is a conceptual diagram illustrating exemplary embodiments of a satellite constellation.

Referring to FIG. 23, a satellite constellation may include satellite 0 to satellite 4. Satellite 0 to satellite 4 may be connected to one another through ISLs. Satellite 3 and satellite 4 may move across the sky toward a direction in which gateway 1 is located. Satellite 0 to satellite 2 may move across the sky toward a direction in which gateway 2 is located. Satellite 0 to satellite 4 may form coverage areas in a service area of AMF entity 1.

Satellite 0 may enter a service area of gateway 2. Satellite 3 may enter the service area of gateway 1. Satellite 2 may leave the service area of gateway 1. Satellite 0 may establish a feeder link with gateway 2. Satellite 2 may release a feeder link with gateway 1. Satellite 3 may establish a feeder link with gateway 1.

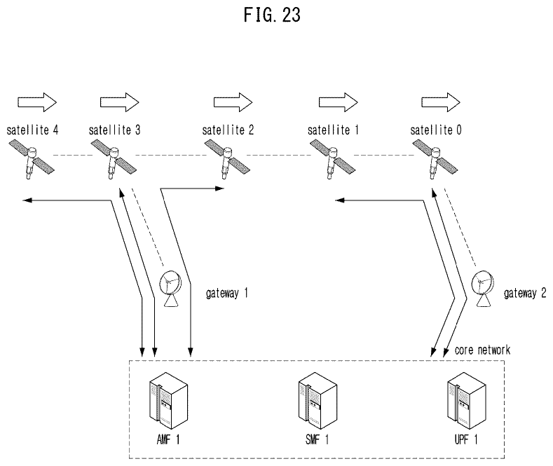

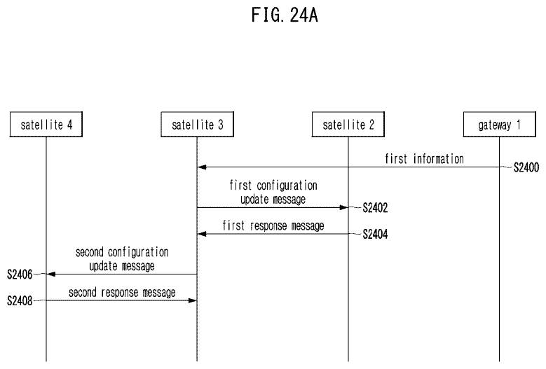

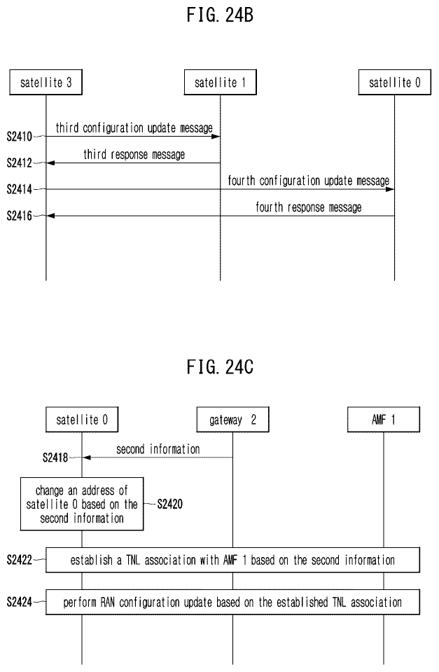

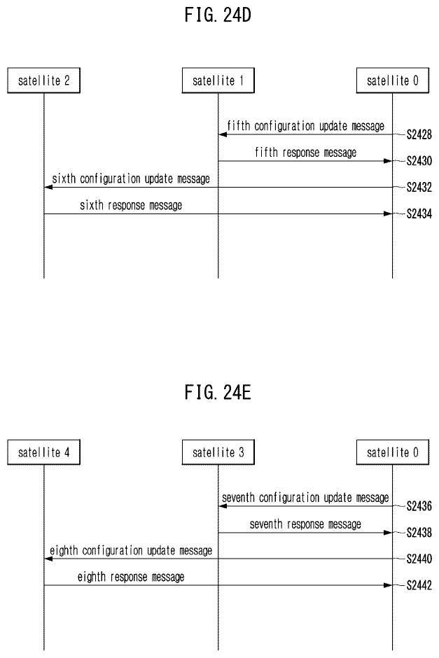

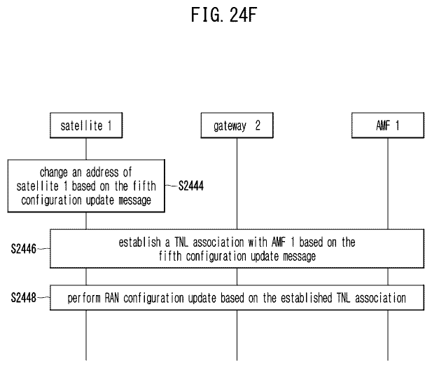

A procedure according to exemplary embodiments illustrated in FIGS. 24A to 24F may be performed after the situation according to exemplary embodiments illustrated in FIG. 23 occurs.

FIGS. 24A to 24F are sequence charts illustrating exemplary embodiments of a RAN configuration update procedure via an anchor satellite.

Referring to FIG. 24A, satellite 3 that establishes a feeder link with gateway 1 may receive first information including at least one of information of an address of gateway 1, information of an address relayed via gateway 1 (e.g. information of an IP address or TNL address of gateway 1), or address information of AMF entity 1 (e.g. information of an IP address or TNL address of AMF entity 1) from gateway 1 (S2400). Satellite 3 that receives the first information may identify that the address of gateway 1 or the address relayed via gateway 1 is the same as its own address. Without establishment of a TNL association or NG setup, satellite 3 may operate as an anchor satellite.

Satellite 3 operating as the anchor satellite may transmit a first configuration update message to satellite 2. After receiving the first configuration update message, satellite 2 may identify satellite 3 as the anchor satellite. Satellite 2 may establish an NG interface with AMF entity 1 through the anchor operation of satellite 3 without establishment of a TNL association or NG setup. Satellite 2 that establishes the NG interface may transmit a first response message to satellite 3 (S2402). The first response message may be transmitted before establishment of the NG interface. Satellite 3 may receive the first response message from satellite 2.

Satellite 3 operating as the anchor satellite may transmit a second configuration update message to satellite 4 (S2406). After receiving the second configuration update message, satellite 4 may identify satellite 3 as the anchor satellite. Satellite 4 may establish an NG interface with AMF entity 1 through the anchor operation of satellite 3 without establishment of a TNL association or NG setup. Satellite 4 that establishes the NG interface may transmit a second response message to satellite 3 (S2408). The second response message may be transmitted before establishment of the NG interface. Satellite 3 may receive the second response message from satellite 4.

Referring to FIG. 24B, satellite 3 operating as the anchor satellite may transmit a third configuration update message to satellite 1 (S2410). After receiving the third configuration update message, satellite 1 may identify satellite 3 as the anchor satellite. Satellite 1 may establish an NG interface with AMF entity 1 through the anchor operation of satellite 3 without establishment of a TNL association or NG setup. Satellite 1 that establishes the NG interface may transmit a third response message to satellite 3 (S2412). The third response message may be transmitted before establishment of the NG interface. Satellite 3 may receive the third response message from satellite 1.

Satellite 3 operating as the anchor satellite may transmit a fourth configuration update message to satellite 0 (S2414). After receiving the fourth configuration update message, satellite 0 may identify satellite 3 as the anchor satellite. Satellite 0 may establish an NG interface with AMF entity 1 through the anchor operation of satellite 3 without establishment of a TNL association or NG setup. Satellite 0 that establishes the NG interface may transmit a fourth response message to satellite 3 (S2416). The fourth response message may be transmitted before establishment of the NG interface. Satellite 3 may receive the fourth response message from satellite 0.

Referring to FIG. 24C, satellite 0 that establishes a feeder link with gateway 2 may receive second information including at least one of information of an address of gateway 2, information of an address relayed via gateway 2 (e.g. information of an IP address or TNL address of gateway 2), or address information of AMF entity 1 (e.g. information of an IP address or TNL address of AMF entity) from gateway 2 (S2418). Satellite 0 that receives the second information may change (or determine) its own address according to the address of gateway 2 or the address relayed via gateway 2 (S2420). Based on the changed address, satellite 0 may establish a TNL association (or SCTP association) with AMF entity 1 (S2422). Satellite 0 may perform a RAN configuration update procedure with AMF entity 1 based on the established TNL association (S2424). Satellite 0 that completes the RAN configuration update procedure may operate as an anchor satellite.

Referring to FIG. 24D, satellite 0 operating as the anchor satellite may transmit a fifth configuration update message to satellite 1 (S2428). After receiving the fifth configuration update message, satellite 1 may identify satellite 0 as the anchor satellite. Satellite 1 that identifies satellite 0 as the anchor satellite may transmit a fifth response message to satellite 0 (S2430). Satellite 0 may receive the fifth response message from satellite 1.

Satellite 0 operating as the anchor satellite may transmit a sixth configuration update message to satellite 2 (S2432). After receiving the sixth configuration update message, satellite 2 may identify satellite 0 as the anchor satellite. Satellite 2 that identifies satellite 0 as the anchor satellite may transmit a sixth response message to satellite 0 (S2434). Satellite 0 may receive the sixth response message from satellite 2.

Referring to FIG. 24E, satellite 0 operating as the anchor satellite may transmit a seventh configuration update message to satellite 3 (S2436). After receiving the seventh configuration update message, satellite 3 may identify satellite 0 as the anchor satellite. Satellite 3 that identifies satellite 0 as the anchor satellite may transmit a seventh response message to satellite 0 (S2438). Satellite 0 may receive the seventh response message from satellite 3.

Satellite 0 operating as the anchor satellite may transmit an eighth configuration update message to satellite 4 (S2440). After receiving the eighth configuration update message, satellite 4 may identify satellite 0 as the anchor satellite. Satellite 4 that identifies satellite 0 as the anchor satellite may transmit an eighth response message to satellite 0 (S2442). Satellite 0 may receive the eighth response message from satellite 4.

Referring to FIG. 24F, satellite 1 may identify at least one of: the fact that satellites 0 and 3 are anchor satellites, the fact that gateway 2 and AMF entity 1 are established in TNL association with satellite 0, the fact that gateway 1 and AMF entity 1 are established in TNL association with satellite 3, the fact that the ISL hop count between satellite 3 and satellite 1 is 2, or the fact that the ISL hop count between satellite 0 and satellite 1 is 1, based on at least one of the third configuration update message or the fifth configuration update message. Satellite 1 may compare the ISL hop count between satellite 3 and satellite 1 and the ISL hop count between satellite 0 and satellite 1. Satellite 1 may determine an anchor satellite used for establishing a TNL association with AMF entity 1 based on a comparison result. Satellite 1 may determine to establish a TNL association with AMF entity 1 anchored by satellite 0, which has a relatively smaller ISL hop count. In another example, when satellite 1 determines the anchor satellite used for establishing the TNL association with AMF entity 1, at least one of traffic load information between satellite 1 and satellite 3 or traffic load information between satellite 1 and satellite 0 may be used.

Satellite 1 may change its own address according to the address of gateway 2 or the address relayed via gateway 2 indicated by the fifth configuration update message. Satellite 1 may establish a TNL association with AMF entity 1 anchored by satellite 0 via gateway 2 based on the changed address. Satellite 1 may perform a RAN configuration update with AMF entity 1 through the anchor operation of satellite 0. The above RAN configuration update procedure (or determination procedure) by satellite 1 may be performed after step S2428 and before step S2430, or after step S2442.

Satellites 2 and 4 may determine the anchor satellite based on the ISL hop count indicated by the configuration update message, as in the procedure in which the anchor satellite is determined by satellite 1. Satellites 2 and 4 may determine satellite 3 as the anchor satellite. Satellites 2 and 4 may maintain the TNL association with AMF entity 1 anchored by satellite 3 without a separate RAN configuration update.

A situation according to exemplary embodiments illustrated in FIG. 25 may occur after the procedure according to exemplary embodiments illustrated in FIG. 22B is completed.

FIG. 25 is a conceptual diagram illustrating exemplary embodiments of a satellite constellation.

Referring to FIG. 25, a satellite constellation may include satellites 0 to 4. Satellites 0 to 4 may be connected to one another through ISLs. Satellites 3 and 4 may move across the sky in a direction where gateway 1 is located. Satellites 0 to 2 may move across the sky in a direction where gateway 2 is located. Satellites 2 to 4 may form coverage areas in a service area of AMF entity 1. Satellites 0 and 1 may form coverage areas in the service area of AMF entity 2.

Satellite 0 may enter the service area of gateway 2 and the service area of AMF entity 2. Satellite 3 may enter the service area of gateway 1 and the service area of AMF entity 1. Satellite 2 may leave the service area of gateway 1. Satellite 0 may establish a feeder link with gateway 2. Satellite 2 may release a feeder link with gateway 1. Satellite 3 may establish a feeder link with gateway 1.

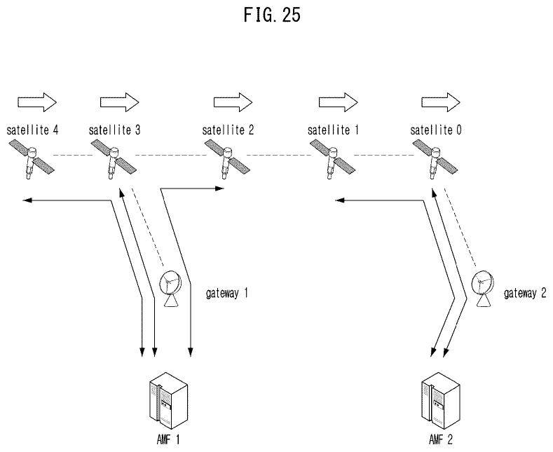

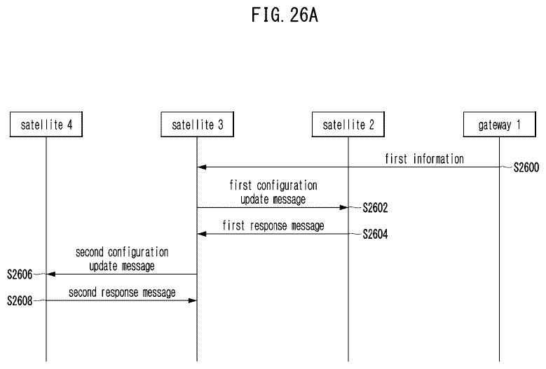

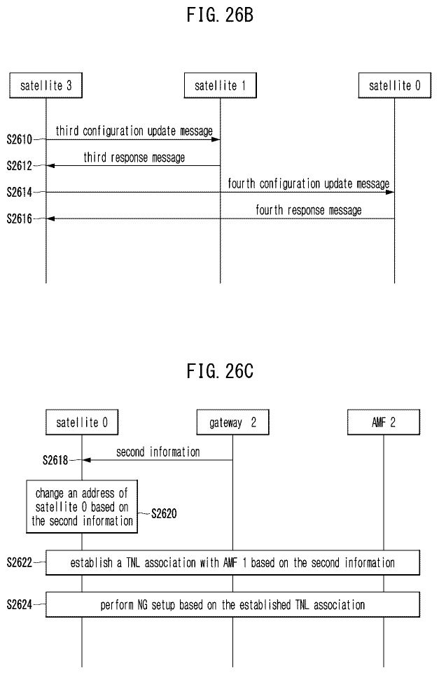

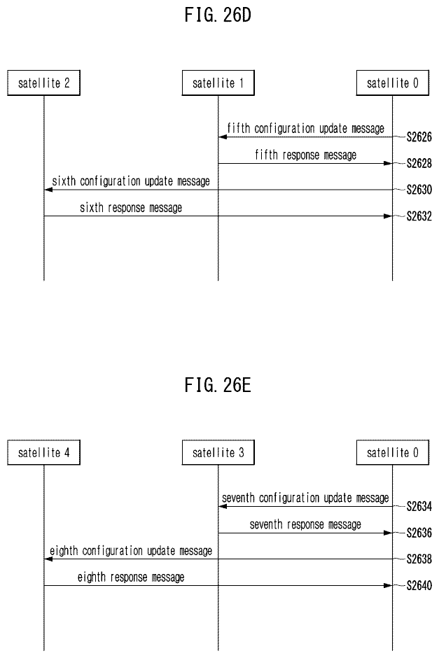

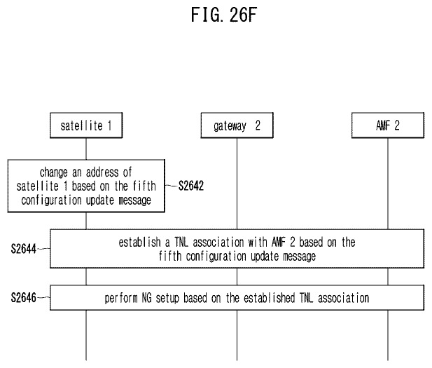

FIGS. 26A to 26F are sequence charts illustrating exemplary embodiments of an NG setup procedure via an anchor satellite.

Referring to FIG. 26A, satellite 3 that establishes a feeder link with gateway 1 may receive first information including at least one of information on an address of gateway 1, information on an address relayed via gateway 1 (e.g. information on an IP address or TNL address of gateway 1), or information on an address of AMF entity 1 (e.g. an IP address or TNL address of AMF entity 1) from gateway 1 (S2600). Satellite 3 that receives the first information may identify that the address of gateway 1 or the address relayed via gateway 1 is the same as its own address. Without establishing a TNL association or NG setup, satellite 3 may operate as an anchor satellite.

Satellite 3 operating as the anchor satellite may transmit a first configuration update message to satellite 2 (S2602). After receiving the first configuration update message, satellite 2 may identify satellite 3 as the anchor satellite. Satellite 2 may establish an NG interface with AMF entity 1 through the anchor operation of satellite 3 without establishing the TNL association or NG setup. Satellite 2 that establishes the NG interface may transmit a first response message to satellite 3 (S2604). The first response message may be transmitted before the NG interface is established. Satellite 3 may receive the first response message from satellite 2.

Satellite 3 operating as the anchor satellite may transmit a second configuration update message to satellite 4 (S2606). After receiving the second configuration update message, satellite 4 may identify satellite 3 as the anchor satellite. Satellite 4 may establish an NG interface with AMF entity 1 through the anchor operation of satellite 3 without establishing the TNL association or NG setup. Satellite 4 that establishes the NG interface may transmit a second response message to satellite 3 (S2608). The second response message may be transmitted before the NG interface is established. Satellite 3 may receive the second response message from satellite 4.

Referring to FIG. 26B, satellite 3 operating as the anchor satellite may transmit a third configuration update message to satellite 1 (S2610). After receiving the third configuration update message, satellite 1 may identify satellite 3 as the anchor satellite. Satellite 1 may establish an NG interface with AMF entity 1 through the anchor operation of satellite 3 without establishing the TNL association or NG setup. Satellite 1 that establishes the NG interface may transmit a third response message to satellite 3 (S2612). The third response message may be transmitted before the NG interface is established. Satellite 3 may receive the third response message from satellite 1.

Satellite 3 operating as the anchor satellite may transmit a fourth configuration update message to satellite 0 (S2614). After receiving the fourth configuration update message, satellite 0 may identify satellite 3 as the anchor satellite. Satellite 0 may establish an NG interface with AMF entity 1 through the anchor operation of satellite 3 without establishing the TNL association or NG setup. Satellite 0 that establishes the NG interface may transmit a fourth response message to satellite 3 (S2616). The fourth response message may be transmitted before the NG interface is established. Satellite 3 may receive the fourth response message from satellite 0.

Referring to FIG. 26C, satellite 0 that establishes a feeder link with gateway 2 may receive second information including at least one of information on the address of gateway 2, information on the address relayed via gateway 2 (e.g. information on the IP address or TNL address of gateway 2), or information on the address of AMF entity 2 (e.g. IP address or TNL address of AMF entity 2) from gateway 2 (S2618). Satellite 0 that receives the second information may change (or determine) its own address according to the address of gateway 2 or the address relayed via gateway 2 (S2620). Based on the changed address, satellite 0 may establish a TNL association (or an SCTP association) with AMF entity 2 (S2622). Satellite 0 may perform an NG setup procedure with AMF entity 2 based on the established TNL association (S2624). Satellite 0 that completes the NG setup procedure may operate as an anchor satellite.

Referring to FIG. 26D, satellite 0 operating as the anchor satellite may transmit a fifth configuration update message to satellite 1 (S2626). After receiving the fifth configuration update message, satellite 1 may identify satellite 0 as the anchor satellite. Satellite 1 that identifies satellite 0 as the anchor satellite may transmit a fifth response message to satellite 0 (S2628). Satellite 0 operating as the anchor satellite may transmit a sixth configuration update message to satellite 2 (S2630). After receiving the sixth configuration update message, satellite 2 may identify satellite 0 as the anchor satellite. Satellite 2 that identifies satellite 0 as the anchor satellite may transmit a sixth response message to satellite 0 (S2632).

Referring to FIG. 26E, satellite 0 operating as the anchor satellite may transmit a seventh configuration update message to satellite 3 (S2634). After receiving the seventh configuration update message, satellite 3 may identify satellite 0 as the anchor satellite. Satellite 3 that identifies satellite 0 as the anchor satellite may transmit a seventh response message to satellite 0 (S2636). Satellite 0 operating as the anchor satellite may transmit an eighth configuration update message to satellite 4 (S2638). After receiving the eighth configuration update message, satellite 4 may identify satellite 0 as the anchor satellite. Satellite 4 that identifies satellite 0 as the anchor satellite may transmit an eighth response message to satellite 0 (S2640).

Referring to FIG. 24F, satellite 1 may identify at least one of: the fact that satellites 0 and 3 are anchor satellites, the fact that gateway 2 and AMF entity 2 are established in TNL association with satellite 0, the fact that gateway 1 and AMF entity 1 are established in TNL association with satellite 3, the fact that the ISL hop count between satellite 3 and satellite 1 is 2, or the fact that the ISL hop count between satellite 0 and satellite 1 is 1, based on at least one of the third configuration update message or the fifth configuration update message. Satellite 1 may compare the ISL hop count between satellite 3 and satellite 1 and the ISL hop count between satellite 0 and satellite 1. Satellite 1 may determine one of maintaining the NG interface with AMF entity 1 established based on the TNL association anchored by satellite 3 or performing NG setup with AMF entity 2 based on the TNL association anchored by gateway 2, based on a comparison result.

Satellite 1 may determine to perform NG setup with AMF entity 2 based on the TNL association anchored by satellite 0 having a relatively smaller ISL hop count. In another example, when satellite 1 determines one of maintaining the NG interface with AMF entity 1 based on the TNL association anchored by satellite 3 or performing NG setup with AMF entity 2 based on the TNL association anchored by gateway 2, at least one of traffic load information between satellite 1 and satellite 3 or traffic load information between satellite 1 and satellite 0 may be used.

The determination by satellite 1 described above may be performed between step S2626 and step S2628, or after step S2640. Among the satellites belonging to the satellite constellation, satellites other than the anchor satellite (e.g. satellite 1, satellite 2, or satellite 4) may also determine one of maintaining the NG interface with AMF entity 1 based on the TNL association anchored by satellite 3 or performing NG setup with AMF entity 2 based on the TNL association anchored by gateway 2. Satellites 2 and 4 may determine to maintain the NG interface with AMF entity 1. Satellites 2 and 4 may maintain the TNL association (or the NG interface) anchored by satellite 3 with AMF entity 1 without a separate procedure (e.g. a RAN configuration update or an NG setup).

Satellite 1 that determines to perform NG setup with AMF entity 2 may change (or determine) its own address according to the address of gateway 2 indicated by the fifth configuration update message or the address relayed via gateway 2 (S2642). Satellite 1 that changes its own address may establish the TNL association with AMF entity 2 anchored by satellite 0 based on the changed address (S2644). Satellite 1 may perform NG setup with AMF entity 2 based on the established TNL association (S2646).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first satellite, comprising:
receiving one or more configuration update messages from one or more satellites connected to the first satellite;
determining an anchor satellite among the one or more satellites based on the one or more configuration update messages; and
establishing a connection with an access and mobility management function (AMF) entity connected to the anchor satellite.

2. The method of claim 1, wherein the establishing of the connection with the AMF entity comprises:
determining an address of the first satellite based on an address of a gateway or an address relayed via the gateway, which is indicated by at least one of the one or more configuration update messages; and
establishing a transport network layer (TNL) association with the AMF entity connected to the anchor satellite based on the address of the gateway or the address relayed via the gateway.

3. The method of claim 2, wherein the establishing of the connection with the AMF entity further comprises performing a next generation (NG) setup procedure with the AMF entity based on the TNL association.

4. The method of claim 2, wherein the establishing of the connection with the AMF entity further comprises performing a radio access network (RAN) configuration update procedure with the AMF entity based on the TNL association.

5. The method of claim 1, wherein each of the one or more configuration update messages includes at least one of: identification information of each of the one or more satellites, address information of each of the one or more satellites, identification information of a gateway connected to each of the one or more satellites, information on an address of the gateway connected to each of the one or more satellites, information on an address relayed via the gateway, identification information of an AMF entity connected to each of the one or more satellites, address information of the AMF entity connected to each of the one or more satellites, information on a hop count through an inter satellite link (ISL) between each of the one or more satellites and the first satellite, or information on traffic load through the ISL between each of the one or more satellites and the first satellite.

6. The method of claim 1, wherein a hop count between the anchor satellite and the first satellite is less than or equal to a hop count between the first satellite and at least one of the one or more satellites other than the anchor satellite.

7. A method of a second satellite, comprising:
receiving, from a gateway, address information on an address of the gateway or information on an address relayed via the gateway;
transmitting, to a first satellite connected to the second satellite, a configuration update message including the address information; and
receiving, from the first satellite, a response message for the configuration update message.

8. The method of claim 7, further comprising establishing a connection with an access and mobility management function (AMF) entity connected to the gateway after receiving the address information,
wherein the establishing of the connection with the AMF entity comprises:
determining an address of the second satellite based on the address information; and
establishing a transport network layer (TNL) association with a core network entity connected to the gateway based on the address information.

9. The method of claim 8, wherein the establishing of the connection with the core network entity further comprises performing a next generation (NG) setup procedure with the AMF entity based on the TNL association.

10. The method of claim 8, wherein the establishing of the connection with the core network entity further comprises performing a radio access network (RAN) configuration update procedure with the core network entity based on the TNL association.

11. The method of claim 7, wherein the configuration update message is transmitted based on a comparison result between the address of the gateway indicated by the address information and an address of the second satellite, or a comparison result between the address relayed via the gateway and the address of the second satellite.

12. The method of claim 7, wherein the configuration update message includes at least one of: identification information of the second satellite, address information of the second satellite, identification information of the gateway, information on the address of the gateway, information on the address relayed via the gateway, identification information of a core network entity connected to the second satellite, address information of the core network entity connected to the second satellite, information on a hop count through an inter-satellite link (ISL) between the second satellite and the first satellite, or information on traffic load through the ISL between the second satellite and the first satellite.

13. A first satellite comprising at least one processor, wherein the at least one processor causes the first satellite to perform:
receiving one or more configuration update messages from one or more satellites connected to the first satellite;
determining an anchor satellite among the one or more satellites based on the one or more configuration update messages; and
establishing a connection with an access and mobility management function (AMF) entity connected to the anchor satellite.

14. The first satellite of claim 13, wherein in the establishing of the connection with the AMF entity, the at least one processor further causes the first satellite to perform:
determining an address of the first satellite based on an address of a gateway or an address relayed via the gateway, which is indicated by at least one of the one or more configuration update messages; and
establishing a transport network layer (TNL) association with the AMF entity connected to the anchor satellite based on the address of the gateway or the address relayed via the gateway.

15. The first satellite of claim 14, wherein in the establishing of the connection with the AMF entity, the at least one processor further causes the first satellite to perform: performing a next generation (NG) setup procedure with the AMF entity based on the TNL association.

16. The first satellite of claim 14, wherein in the establishing of the connection with the AMF entity, the at least one processor further causes the first satellite to perform: performing a radio access network (RAN) configuration update procedure with the AMF entity based on the TNL association.

17. The first satellite of claim 13, wherein each of the one or more configuration update messages includes at least one of: identification information of each of the one or more satellites, address information of each of the one or more satellites, identification information of a gateway connected to each of the one or more satellites, information on an address of the gateway connected to each of the one or more satellites, information on an address relayed via the gateway, identification information of an AMF entity connected to each of the one or more satellites, address information of the AMF entity connected to each of the one or more satellites, information on a hop count through an inter satellite link (ISL) between each of the one or more satellites and the first satellite, or information on traffic load through the ISL between each of the one or more satellites and the first satellite.

18. The first satellite of claim 13, wherein a hop count between the anchor satellite and the first satellite is less than or equal to a hop count between the first satellite and at least one of the one or more satellites other than the anchor satellite.
